(19) United States
(12) Patent Application Publication
(10) Pub. No.: US 2018/0041540 A1
(43) Pub. Date: Feb. 8, 2018

(54) METHOD TO DETECT AND PROTECT AGAINST REMOTE CONTROL

(71) Applicants: Egemen Tas, Bloomfield, NJ (US); Haibo Zhang, Bejing (CN)

(72) Inventors: Egemen Tas, Bloomfield, NJ (US); Haibo Zhang, Bejing (CN)

(21) Appl. No.: 15/223,903

(22) Filed: Jul. 29, 2016

(51) Int. Cl. H04L 29/06

(52) U.S. Cl. CPC H04L 63/1441; H04L 63/10

(57) ABSTRACT

The current invention discloses method and system to detect remote control and prevent critical application from being peeped at and manipulated. Solution includes remote control detection, remote control blocking and user interaction.

When remote access is detected, all suspicious behaviors found during network protocol filtering, session id based detection and remote control behaviour analysis are blocked.

Innovative and efficient remote detection methods support user space and kernel space mode, intercept function modules for running applications and services to check and verify. Also new detective methods support network packets filter to judge accurate remote activities.

### BACKGROUND

Remote connection that is supported by operating system and that can manipulate computers from unauthorized remote control is a security challenge to critical business like browsers, email clients, etc, which causes leakage of sensitive information.

Most operating systems support multiple sessions for remote access of all kinds. While one operates on desktop, other terminals could watch the same screen output or create a new parallel session on the same machine. Operating system enables isolated sessions that could be manipulated by different remote users. By getting remote access, attackers can retrieve sensitive information easily. Also they can operate directly on sensitive application as if it is being operated by legal owner.

Traditional remote access detection methods just capture the network packets and analyze the protocol content. Or just record the TCP or UDP network connection and check if it matches the strategy and rules. These control policies behave as Firewall does.

Some methods can watch the remote running rely service and application verifying if these executed files are signed or valid.

Network packets capturing and analyzing can not recognize the remote access behaviors accurately. Firewall solution focuses only on specific port and address to watch. Agent services and application watching verify the validation of the executed files, but also can not recognize the hostile remote process operated behaviors.

Even some antivirus and anti-malware solutions that are watching and recording the process activities, can not determine the accurate remote access related behaviors.

Thus, there is a need in new method that would provide solution for efficient remote detection that is capable to recognize access behaviours in accurate manner and to diagnose hostile intrusion if any.

### SUMMARY OF INVENTION

The current invention is a method and system to detect remote control and prevent critical application from being peeped at and manipulated.

When remote access is detected, all suspicious behaviors found during network protocol filtering, session id based detection and remote control behaviour analysis are blocked. In this way remote terminal is not able to connect to target system, nor can it control target system by sending keyboard/mouse activities or steal sensitive information by capturing screen.

Innovative and efficient remote detection methods support user space and kernel space mode, intercept function modules for running applications and services to check and verify. Also new detective methods support network packets filter to judge remote activities accurately.

Invention methods use intuitive techniques to prompt user for risks and protect critical application from being leaked.

### BRIEF DESCRIPTION OF DRAWINGS

FIG. 1 shows the general scheme of the invention

FIG. 2 is a depiction of remote control detection process

FIG. 3 is a flowchart of session id based detection process

FIG. 4 is a flowchart of network filtering process

FIG. 5 is a depiction of behavior analysis process

FIGS. 6a and 6b are depiction of one embodiment of the invention where user is informed about potential risk

FIG. 7 is a schematic of the memory and hardware of a computer or handheld device such as a tablet or smartphone.

FIG. 8 is a schematic of an individual user operating a computer or handheld device connected to the internet.

FIG. 9 illustrates computer devices.

### DETAILED DESCRIPTION

The present invention discloses a method and system to detect remote control and secure computer system from hostile intrusions. Solution includes remote control detection, remote control blocking and user interaction.

Technically there are two ways to get remote access of a computer. First works through Windows RDP which is a built-in component of operating system. It is session based. And the second is based on other third part solutions which capture screens and send keyboard/mouse events to target system via standard Windows APIs.

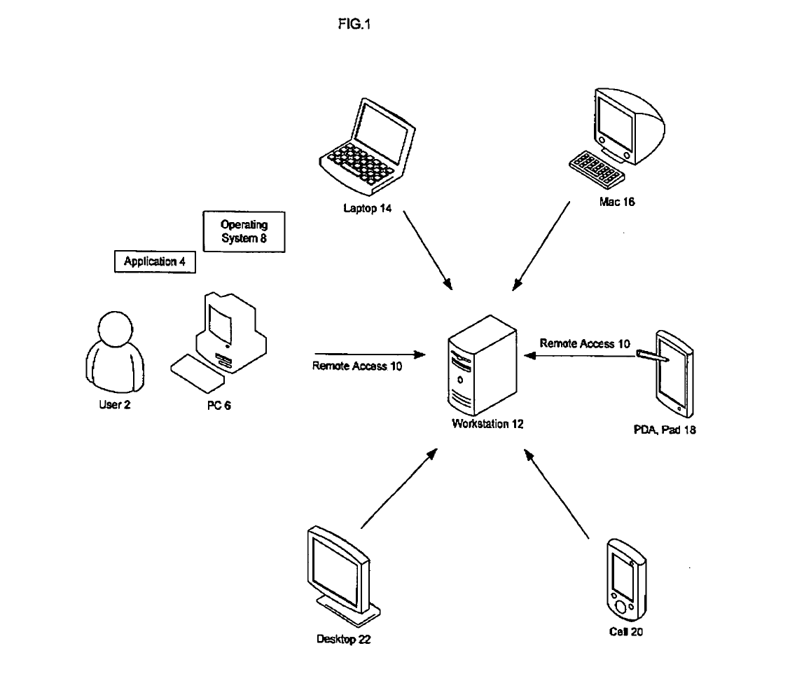

In FIG. 1 the general scheme of the invention is shown. The user 2 opens an application 4 on computer 6 which has operating system 8 installed, that supports multiple sessions for remote access 10 through workstation 12. Also remote access 10 can be implemented for laptop 14, Mac computer 16, PDA, Pad 18, cell phone 20 and desktop 22.

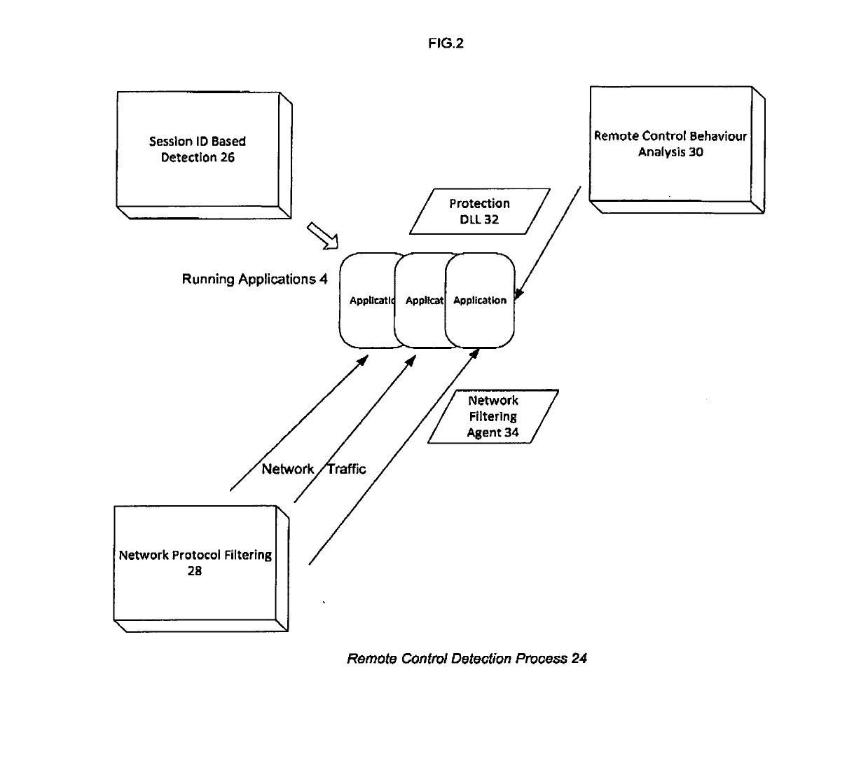

FIG. 2 demonstrates depiction of remote control detection process 24. It comprises session id based detection 26, network protocol filtering 28 and remote control behavior analysis 30. In order to implement these features protection dll 32 is injected into all running applications 4 and network filtering agent 34, intercepting network traffic for all applications 4, is setup.

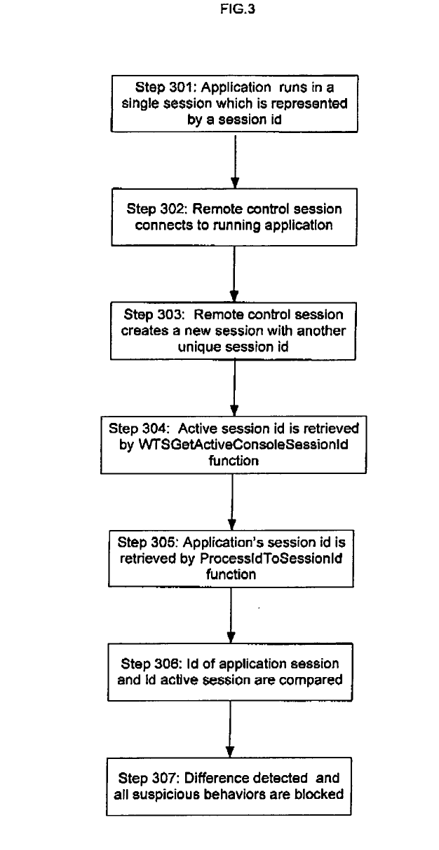

FIG. 3 shows the flowchart of session id based detection process 26. In step 301 application 4 runs in a single session which is represented by a session id 36. In step 302 remote control session connects to running application 4. In step 303 remote control session creates a new session with another unique session id 36. In step 304 active session id 36 is retrieved by WTSGetActiveConsoleSessionId function. In step 305 application's session id 36 is retrieved by ProcessIdToSessionId function. In step 306 id of application session and id of active session are compared. If they are different that means the application 4 is being monitored by another session and thus all suspicious behaviors are blocked, step 307.

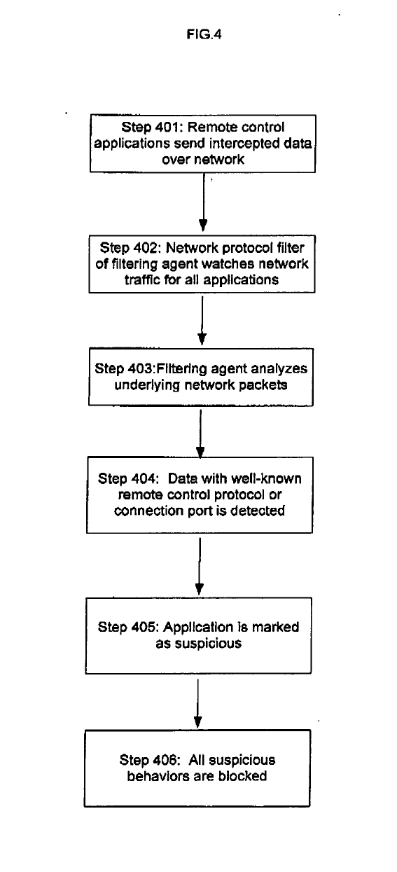

In FIG. 4 the flowchart of network filtering process is shown. In step 401 remote control applications 38 send intercepted data over network, using certain port (e.g. 3306 for RDP) for data transferring. In step 402 network protocol filter of filtering agent 34 watches network traffic for all applications 4. In step 403 filtering agent 34 analyzes underlying network packets. If data with well-known remote control protocol or connection port is detected, step 404, the application 4 is marked as suspicious, step 405. In step 406 all suspicious behaviors are blocked.

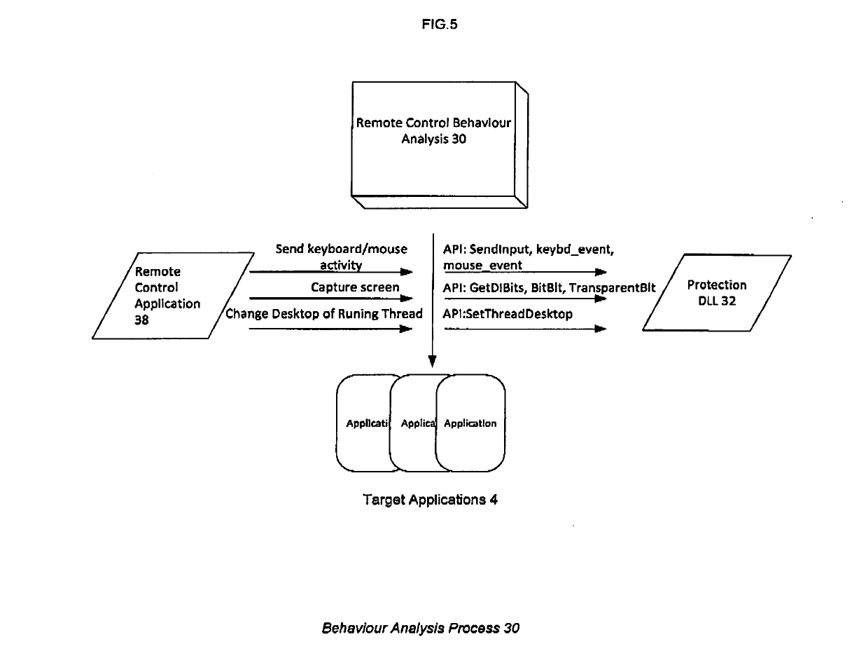

FIG. 5 demonstrates depiction of behavior analysis process. Most remote control applications 38 have the following behaviors in target system: they are sending keyboard/mouse activity, capturing screen, changing desktop 22 of running thread if target application 4 runs in a separate desktop. All these behaviors are intercepted by API hooks in injected dll 32. Related APIs are SendInput, keybd_event, mouse event, GetDIBits, BitBlt, TransparentBlt, SetThreadDesktop, etc. Thus invention method reaches more precise detection by combining behavior analysis and network traffic analysis.

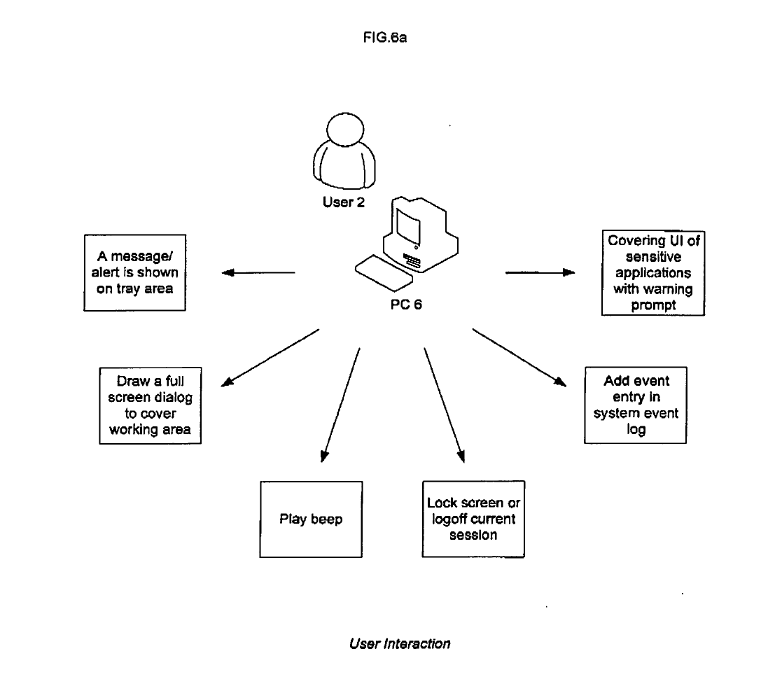

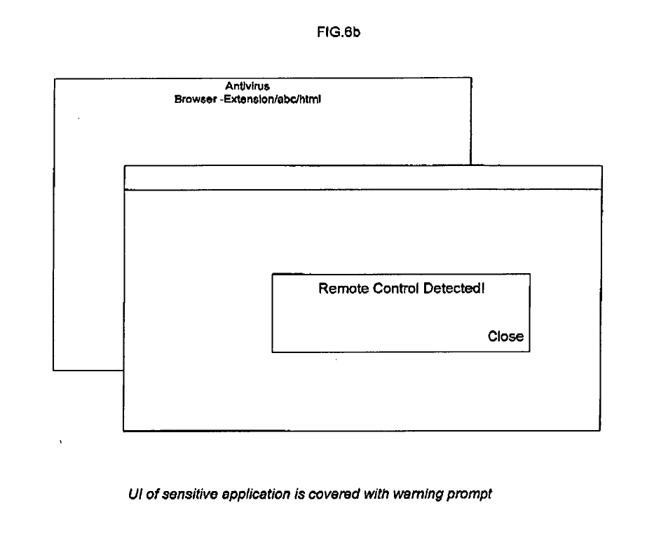

FIGS. 6a and 6b show depiction of one embodiment of the invention where user 2 is informed about potential risk. When a remote connection or remote access 10 is detected, current desktop user 2 is informed about potential risk and critical information (e.g. email, browsers, visible sensitive information like CAD designs, etc) is prevented from being leaked. To achieve this protection there can be applied number of actions. For example, UI of sensitive applications 4 can be covered with warning prompt to avoid information leakage. This can be achieved in two ways. The first is intercepting WM_ERASEBKGND and WM_PAINT messages by calling SetWindowsHookEx(WM_CALLWNDPROC) or SetWindowLong( ). Then it is necessary to modify DC handle used to paint dialog so that real content of protection application is not drawn on screen. Instead there can be drawn warning information to prompt user for potential risks. And the second way is creating a new foreground covering dialog which covers UI of sensitive application 4. Then it is necessary to intercept window movement messages of protected application by calling SetWindowsHookEx(WH_CALLWNDPROC) or SetWindowLong( ) and move covering dialog according when messages WM_MOVE/WM_SIZING/WM_WINDOWPOSCHANGED/WM_WINDOWPOSC HANGING/WM_SYSCOMMAND/WM_SHOWWINDOW are intercepted so that it could always move with protected application 4 and cover it. Another action to be applied to inform user 2 about the threat is to show a message/alert on tray area. Or there can be drawn a full screen dialog to cover working area to prompt for potential risks so that visible sensitive information is not leaked. Playing beep can also remind user 2 of potential risk. Or system can lock screen or logoff current session, so that controller needs to input Windows account credentials to login. Finally the event entry can be added in system event log so that administrator can trace and review.

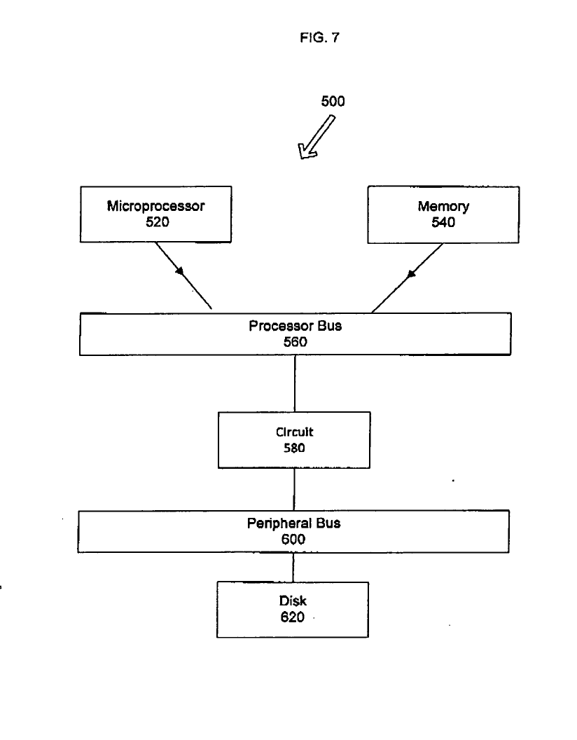

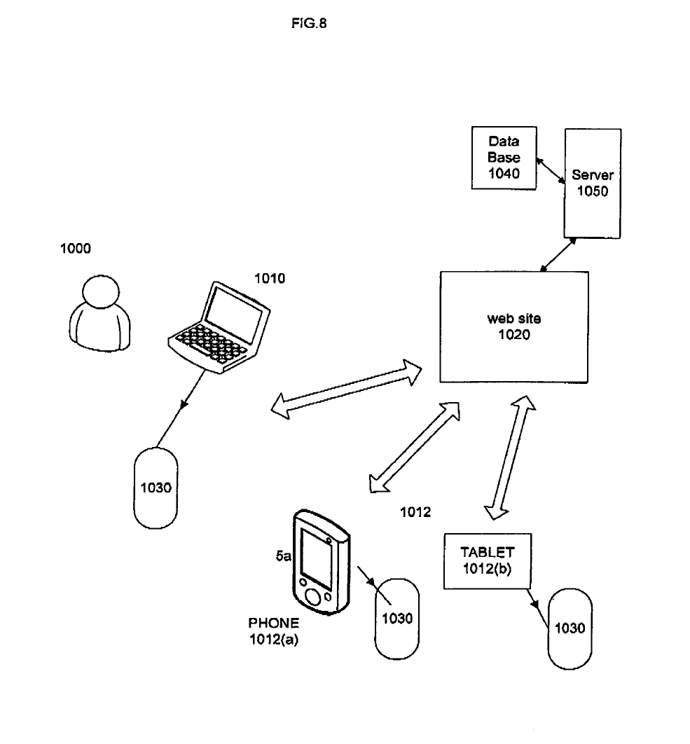

The system and method of the present invention may be used with exemplary computer systems and devices as shown in FIGS. 7 and 8. FIG. 7 illustrates a system 500 of a computer or device which includes a microprocessor 520 and a memory 540 which are coupled to a processor bus 560 which is coupled to a peripheral bus 600 by circuitry 580. The bus 600 is communicatively coupled to a disk 620. It should be understood that any number of additional peripheral devices are communicatively coupled to the peripheral bus 600 in embodiments of the invention. Further, the processor bus 560, the circuitry 580 and the peripheral bus 600 compose a bus system for computing system 500 in various embodiments of the invention. The microprocessor 520 starts disk access commands to access the disk 620. Commands are passed through the processor bus 560 via the circuitry 580 to the peripheral bus 600 which initiates the disk access commands to the disk 620. In various embodiments of the invention, the present system intercepts the disk access commands which are to be passed to the hard disk.

As shown generally by FIG. 8, there is a user 1000 of a computer 1010 or handheld device 1012 who accesses an Internet website 1020 with network connections to a server 1050 and database 1040. The computer 1010 or handheld device is compatible with operating systems known in the art, such as Windows, iOS or android devices or android type operating systems. The user 1000 is potentially exposed to many malicious or unsafe applications located on the web or a particular website 1020 due to lack of security and validation with the source, even though the website 1020 itself may be known as reliable and trusted. The website may be an application store or directory which includes other software applications for downloading. Similarly, receiving email may introduce unsafe internet links, applications and attachments to the user's computer or device. Those of skill in the art would recognize that the computer 1010 or hand held devices 1012a or 1012b each has a processor and a memory coupled with the processor where the memory is configured to provide the processor with executable instructions. A boot disk 1030 is present for initiating an operating system as well for each of the computer 1010 or hand held devices 1012. It should also be noted that as used herein, the term handheld device includes phones, smart phones, tablets, personal digital assistants, media and game players and the like. It should also be understood that the user's computer or device may be part of an internal network or system which is communicating with the Internet. As used throughout the specifications, the term “query” or “queries” is used in the broadest manner to include requests, polls, calls, summons, queries, and like terms known to those of skill in the art.

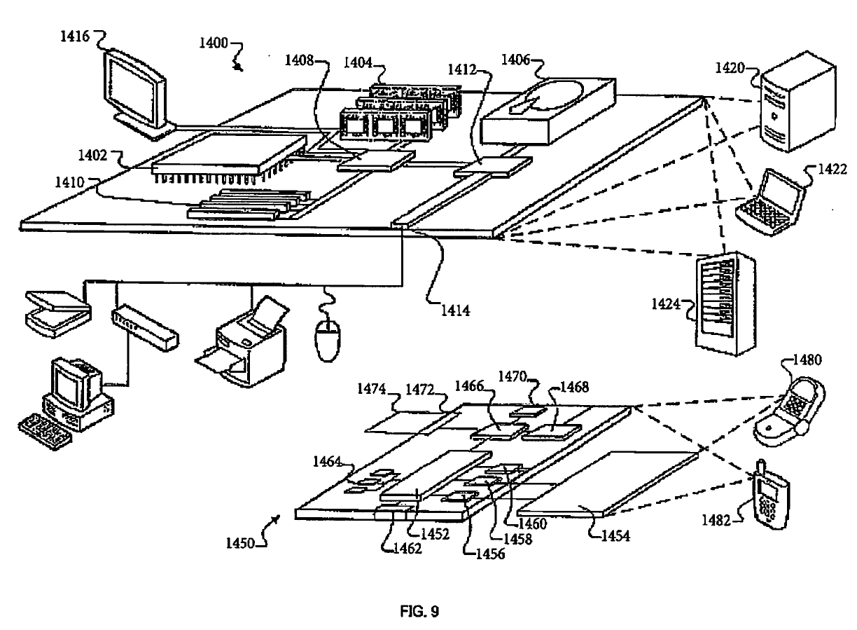

FIG. 9 shows an example of a generic computer device 1400 and a generic mobile computer device 1450, which may be used to implement the processes described herein, including the mobile-side and server-side processes for installing a computer program from a mobile device to a computer. Computing device 1400 is intended to represent various forms of digital computers, such as laptops, desktops, workstations, personal digital assistants, servers, blade servers, mainframes, and other appropriate computers. Computing device 1450 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 1400 includes a processor 1402, memory 1404, a storage device 1406, a high-speed interface 1408 connecting to memory 1404 and high-speed expansion ports 1410, and a low speed interface 1412 connecting to low speed bus 1414 and storage device 1406. Each of the components 1402, 1404, 1406, 1408, 1410, and 1412 are interconnected using various busses, and may be mounted on a common motherboard or in other manners as appropriate. The processor 1402 can process instructions for execution within the computing device 1400, including instructions stored in the memory 1404 or on the storage device 1406 to display graphical information for a GUI on an external input/output device, such as display 1416 coupled to high speed interface 1408. In other implementations, multiple processors and/or multiple busses may be used, as appropriate, along with multiple memories and types of memory. Also, multiple computing devices 1400 may be connected, with each device providing portions of the necessary operations (e.g., as a server bank, a group of blade servers, or a multi-processor system).

The memory 1404 stores information within the computing device 1400. In one implementation, the memory 1404 is a volatile memory unit or units. In another implementation, the memory 1404 is a non-volatile memory unit or units. The memory 1404 may also be another form of computer-readable medium, such as a magnetic or optical disk.

The storage device 1406 is capable of providing mass storage for the computing device 1400. In one implementation, the storage device 1406 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 1404, the storage device 1406, or memory on processor 1402.

The high speed controller 1408 manages bandwidth-intensive operations for the computing device 1400, while the low speed controller 1412 manages lower bandwidth-intensive operations. Such allocation of functions is exemplary only. In one implementation, the high-speed controller 1408 is coupled to memory 1404, display 1416 (e.g., through a graphics processor or accelerator), and to high-speed expansion ports 1410, which may accept various expansion cards (not shown). In the 10 implementation, low-speed controller 1412 is coupled to storage device 1406 and low-speed expansion port 1414. The low-speed expansion port 1414, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 1400 may be implemented in a number of different forms, as shown in the figure. For example, it may be implemented as a standard server 1420, or multiple times in a group of such servers. It may also be implemented as part of a rack server system 1424. In addition, it may be implemented in a personal computer such as a laptop computer 1422. Alternatively, components from computing device 1400 may be combined with other components in a mobile device (not shown), such as device 1450. Each of such devices may contain one or more of computing device 1400, 1450, and an entire system may be made up of multiple computing devices 1400, 1450 communicating with each other.

Computing device 1450 includes a processor 1452, memory 1464, an input/output device such as a display 1454, a communication interface 1466, and a transceiver 1468, among other components. The device 1450 may also be provided with a storage device, such as a Microdrive or other device, to provide additional storage. Each of the components 1450, 1452, 1464, 1454, 1466, and 1468 are interconnected using various busses, and several of the components may be mounted on a common motherboard or in other manners as appropriate.

The processor 1452 can execute instructions within the computing device 1450, including instructions stored in the memory 1464. The processor may be implemented as a chipset of chips that include separate and multiple analog and digital processors. The processor may provide, for example, for coordination of the other components of the device 1450, such as control of user interfaces, applications run by device 1450, and wireless communication by device 1450.

Processor 1452 may communicate with a user through control interface 1458 and display interface 1456 coupled to a display 1454. The display 1454 may be, for example, a TFT LCD (Thin-Film-Transistor Liquid Crystal Display) or an OLED (Organic Light Emitting Diode) display, or other appropriate display technology. The display interface 1456 may comprise appropriate circuitry for driving the display 1454 to present graphical and other information to a user. The control interface 1458 may receive commands from a user and convert them for submission to the processor 1452. In addition, an external interface 1462 may be provided in communication with processor 1452, so as to enable near area communication of device 1450 with other devices. External interface 1462 may provide, for example, for wired communication in some implementations, or for wireless communication in other implementations, and multiple interfaces may also be used.

The memory 1464 stores information within the computing device 1450. The memory 1464 can be implemented as one or more of a computer-readable medium or media, a volatile memory unit or units, or a non-volatile memory unit or units. Expansion memory 1474 may also be provided and connected to device 1450 through expansion interface 1472, which may include, for example, a SIMM (Single in Line Memory Module) card interface. Such expansion memory 1474 may provide extra storage space for device 1450, or may also store applications or other information for device 1450. Specifically, expansion memory 1474 may include instructions to carry out or supplement the processes described above, and may include secure information also. Thus, for example, expansion memory 1474 may be provide as a security module for device 1450, and may be programmed with instructions that permit secure use of device 1450. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1464, expansion memory 1474, memory on processor 1452, or a propagated signal that may be received, for example, over transceiver 1468 or external interface 1462.

Device 1450 may communicate wirelessly through communication interface 1466, which may include digital signal processing circuitry where necessary. Communication interface 1466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1468. In addition, short range communication may occur, such as using a Bluetooth, Wi-Fi, or other such transceiver (not shown). In addition, GPS (Global Positioning System) receiver module 1470 may provide additional navigation- and location-related wireless data to device 1450, which may be used as appropriate by applications running on device 1450.

Device 1450 may also communicate audibly using audio codec 1460, which may receive spoken information from a user and convert it to usable digital information. Audio codec 1460 may likewise generate audible sound for a user, such as through a speaker, e.g., in a handset of device 1450. Such sound may include sound from voice telephone calls, may include recorded sound (e.g., voice messages, music files, etc.) and may also include sound generated by applications operating on device 1450.

The computing device 1450 may be implemented in a number of different forms, as shown in the figure. For example, it may be implemented as a cellular telephone 1480. It may also be implemented as part of a smartphone 1482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the invention.

As would be understood in the art, the computer, the processor, microprocessor, controller, control unit or other programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, an artisan understands and appreciates that a “processor”, “microprocessor” “controller”, or “control unit” or “microcontroller” constitute hardware in the claimed disclosure that contain circuitry that is configured for operation with software or firmware, and may be construed as implicitly including Digital Signal Processor (DSP) hardware.

The definition of the terms “unit” or “module” as referred to herein is to be understood as constituting hardware circuitry such as a processor or microprocessor configured for a certain desired functionality, or a communication module containing hardware such as transmitter, receiver or transceiver, or a non-transitory medium comprising machine executable code that is loaded into and executed by hardware for operation.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Elements of different implementations described herein may be combined to form other implementations not specifically set forth above. Elements may be left out of the processes, computer programs, Web pages, etc. described herein without adversely affecting their operation. Furthermore, various separate elements may be combined into one or more individual elements to perform the functions described herein.

The invention is not restricted to the details of the foregoing embodiments. The invention extends to any novel one, or any novel combination, of the features disclosed in this specification (including any accompanying claims, abstract and drawings), or to any novel one, or any novel combination, of the steps of any method or process so disclosed.

What is claimed is:

1. A method and system to detect remote control and secure computer system from hostile intrusions comprising:
Remote control detection,
Remote control blocking, and
User interaction

2. A method according to claim 1, where detect remote control comprises:
Session id based detection,
Network protocol filtering, and
Remote control behaviour analysis.

3. A method according to claim 1, where protection dll is injected into all running applications and network filtering agent is setup to intercept network traffic for all applications.

4. A method according to claim 1, where all suspicious behaviours found during network protocol filtering, session id based detection and remote control behavior analysis are blocked.

5. A method according to claim 1, where desktop user is informed about potential risk and critical information (e.g. email, browsers, visible sensitive information like CAD designs, etc) is prevented from being leaked, if remote connection is detected, comprising:
Covering UI of sensitive applications with warning prompt,
Showing message/alert on tray area,
Drawing a full screen dialog to cover working area to prompt for potential risks so that visible sensitive information is not leaked,
Playing beep to remind current user of potential risk,
Locking screen or logoff current session, so that controller needs to input Windows account credentials to login, and
Adding event entry in system event log so that administrator can trace and review.
